(19) United States
(12) Patent Application Publication
(10) Pub. No.: US 2006/0104630 A1
(43) Pub. Date: May 18, 2006

(54) Photographic film notching scanner correction

(76) Inventors: David J. Cornell, Scottsville, NY (US); Joel S. Lawther, East Rochester, NY (US); David C. Smart, Fairport, NY (US)

Correspondence Address: Mark G. Bocchetti;Patent Legal Staff, Eastman Kodak Company, 343 State Street, Rochester, NY, 14650-2201, US

(21) Appl. No.: 10/989,859

(22) Filed: Nov. 15, 2004

(51) Int. Cl. G03B 17/24

(52) U.S. Cl. 396/311

(57) ABSTRACT

A film camera assembly has a taking lens and an aligned baffle. A film metering mechanism is actuable to transport the photographic film in a longitudinal direction past the baffle. A film support is aligned with the baffle and defines a pair of film stations separated by a light-blocking interspace mask. The first film station has an exposure opening and a pair of lateral edges adjoining the exposure opening. The second film station has a light-blocking image mask and an elongate demarcation opening adjoining the image mask in a second direction perpendicular to the direction of film transport. The exposure opening and demarcation opening are equal in length. The demarcation opening is aligned with one of the lateral edges.

### CROSS REFERENCE TO RELATED APPLICATIONS

Reference is made to commonly assigned, co-pending U.S. patent application Ser. No. ______, [Attorney Docket No. 86824RLW], entitled: CAMERA WITH IMAGE FRAME DEMARCATION, filed Nov. 15, 2004, in the name(s) of James D. Boyd, Michael P. Cramer, David J. Cornell, David C. Smart, Joel S. Lawther.

### FIELD OF THE INVENTION

The invention relates to film cameras and photography methods and more particularly relates to camera assemblies and method relating to a photographic film notching scanner correction.

### BACKGROUND OF THE INVENTION

Most cameras that use Type 135 (“35 mm”) photographic film capture images in full “film frames”, units of film of a standard size of 24 mm by 36 mm. Some cameras that use 35 mm film capture what are referred to as “half-frame” images, which have a standard size of 18 mm by 24 mm. In both cases, the locations of images on the exposed film are standardized, in a crosswise or lateral direction (the smaller film dimension). In most 35 mm cameras, the gap between images, sometimes referred to as an “interspace”, also has a standardized length in a longitudinal direction. In some 35 mm cameras, the interspace length varies. Typically, this is due to use of a film metering procedure, in which the length of a film frame-interspace segment is determined by the length of film taken up by rotating a spool through a predetermined range of rotation. This approach, sometimes referred to as “convolution winding”, results in an interspace longitudinal dimension that varies with the diameter of the spool plus the roll of film previously wound onto the spool.

Image locations are not standardized in a longitudinal direction. As a result, the length of a leader and/or trailer of a 35 mm filmstrip varies from camera type to camera type and, with some cameras, from user to user, depending upon how film is manually loaded. The number of images on a filmstrip of standard length can also vary. For these reason, procedures have been developed in film photofinishing to identify the longitudinal locations of images so as to permit automated printing of images from developed negatives. Those procedures typically place detectible marks, such as notches on filmstrips to indicate image positions. (The marks are detectable, but otherwise can take a variety of forms, such as cutouts, markings on the film, and computer entries. For convenience, all such marks are referred to herein as notches.) Filmstrips are spliced together into a large roll, which is then printed in a continuous operation using the notches.

In some current photofinishing, “film notch” scanners scan developed filmstrips, detect full size images, and then notch the filmstrips to indicate the locations of the images and the leader and trailer of each filmstrip. Examples of film notch scanners are disclosed in U.S. Pat. No. 3,787,701 and U.S. Pat. No. 4,641,019. In at least some film notch scanners, a full size image is detected when image content is present both in a laterally central area of the image frame and over the full length of the image frame. Failure to detect a full frame size image is interpreted as the presence on a filmstrip of a partial image. This can occur when a user attempts to capture an image on a film frame that partially overlaps a previously exposed film leader.

Film notch scanners can be used with cameras that expose half-frame images. The scanners can be modified to accommodate a frame length equal to that of a half-frame. This can be done, but then different equipment is needed for full and half-frame filmstrips, or each scanner must, on the fly, identify frame length and modify operation, as needed. U.S. Pat. No. 5,541,690 discloses a partial solution. Film is transported such that two half-frame images are captured in the same space as a single full frame image. The two images can neatly meet, or, as a more practical measure, can overlap slightly, with the overlapped area being removed before printing. Each half-frame pair, that is, each pair of contiguous half-frame images, is separated by an ordinary unexposed interspace. This approach allows notching with a standard film notch scanner, since each half-frame pair, that is, pair of contiguous half-frame images, is treated by the film notch scanner as if it were a full frame image. After notching, the half-frame pair is scanned, at higher resolution, by a digital printer scanner, the two half-frame images are separated, any overlap area is removed, and both images are printed.

There is a remaining problem. If a filmstrip has an unpaired half-frame image at the end of the filmstrip, that image is not treated as a full frame image. An unmodified film notch scanner does not identify the half-frame image as being printable.

It would thus be desirable to provide cameras and photography methods, which can be used with the above-described film notch scanners without misidentification of half-fame images at the end of filmstrips as being unprintable.

### SUMMARY OF THE INVENTION

The invention is defined by the claims. The invention, in broader aspects, provides a film camera assembly has a taking lens and an aligned baffle. A film metering mechanism is actuable to transport the photographic film in a longitudinal direction past the baffle. A film support is aligned with the baffle and defines a pair of film stations separated by a light-blocking interspace mask. The first film station has an exposure opening and a pair of lateral edges adjoining the exposure opening. The second film station has a light-blocking image mask and an elongate demarcation opening adjoining the image mask in a second direction perpendicular to the direction of film transport. The exposure opening and demarcation opening are equal in length. The demarcation opening is aligned with one of the lateral edges.

It is an advantageous effect of the invention that an improved cameras and photography methods are provided, which can be used with the above-described film notch scanners without misidentification of half-fame images at the end of filmstrips as being unprintable.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a front view of an embodiment of the camera frame assembly.

FIG. 2 is a sectional top view of the camera frame assembly of FIG. 1.

FIG. 3 is a sectional rear view of the camera frame assembly of FIGS. 1 and 2. Some dimensions in this and other figures are exaggerated for clarity.

FIG. 4 is a partial sectional rear view of another embodiment of the camera frame assembly.

FIG. 5 is a top view of the main member of the camera frame assembly of a modification of the camera frame assembly of FIG. 4.

FIG. 6 is a schematic view of a filmstrip created by the camera frame assembly of FIGS. 1-3, showing the locations of images and demarcation bars following film development. The filmstrip has an even number of half-frame exposures. The figure of a woman appears in all captured images.

FIG. 7 is the same view as FIG. 6, except one more half-frame image was captured prior to development.

FIG. 8 is a flow chart of an embodiment of the method.

### DETAILED DESCRIPTION OF THE INVENTION

It has been determined, in at least some film notch scanners, that the requirement of a full size image, image content in a laterally central area of the image frame and image content over the full length of the image frame can be met by different features. The laterally central image content does not have to extend over the entire length of the image frame for the film notch scanner to recognize a full frame image. The cameras described herein utilize these features to ensure that all of the half-frame images captured by a user are notched for printing.

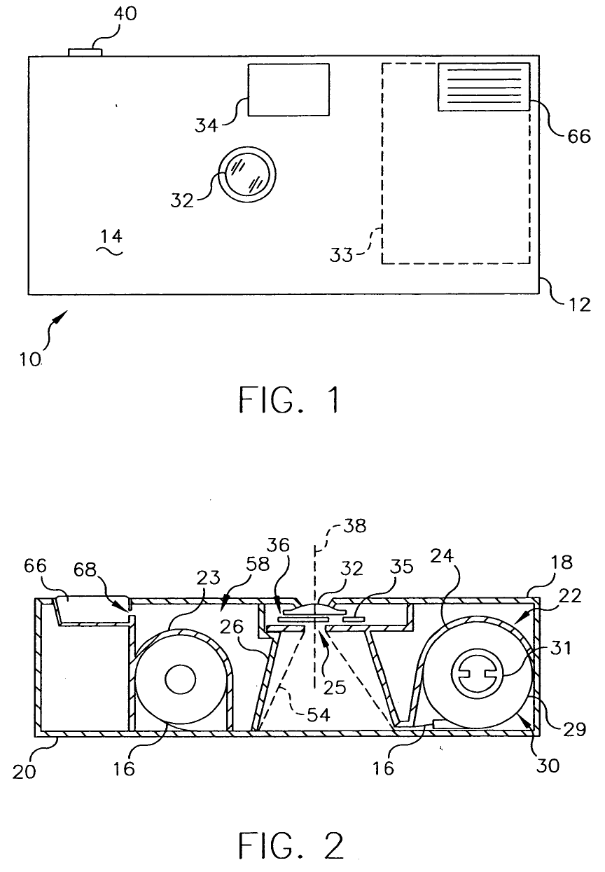

Referring now to FIGS. 1-5, camera 10 has a body 12 that holds an exposure system, which captures light images on a photographic filmstrip 16. The body 12 provides structural support to other components. The body 12 has a shell 14 having a front cover 18 and a rear cover 20 that are joined together. A main member 22 is held between the covers 18, 20. Most camera components are attached to the main member 22 or trapped between the main member 22 and covers 18, 20.

The main member 22 includes first and second film chambers 23, 24, and a film support 28 located between the chambers 23, 24. A baffle 26 extends forward from the film support 28. At the front of the baffle 26, is a shutter mount, which has an aperture 25. The film support 28, chambers 23,24, and baffle 26 can be made in a single piece or in multiple pieces attached together.

The canister 29 of a film unit 30 rests in the second chamber 24. A spool 31 in the canister 29 holds an end of the filmstrip. The filmstrip 16 extends along the film support 28, between the chambers 23, 24 and is coiled in the first chamber 23.

The exposure system includes a taking lens 32, an operating mechanism 36, a viewfinder 34, and a flash unit 33. Most features of the exposure system are only briefly discussed here, since such components are well known to those of skill in the art.

The taking lens 32 is held in alignment with the film support 28, by the main member 22. The taking lens 32 directs light through the aperture 25 and then, as a light cone, through baffle 26 to the film support 28. The taking lens 32 includes one or more lens elements, which define an optical axis 38. The viewfinder 34 is disposed in the body 12 and is aligned with the taking lens 32 to show substantially the same scene image. The viewfinder 34 extends through the main member 22 and can include front and rear viewfinder lenses (not separately illustrated).

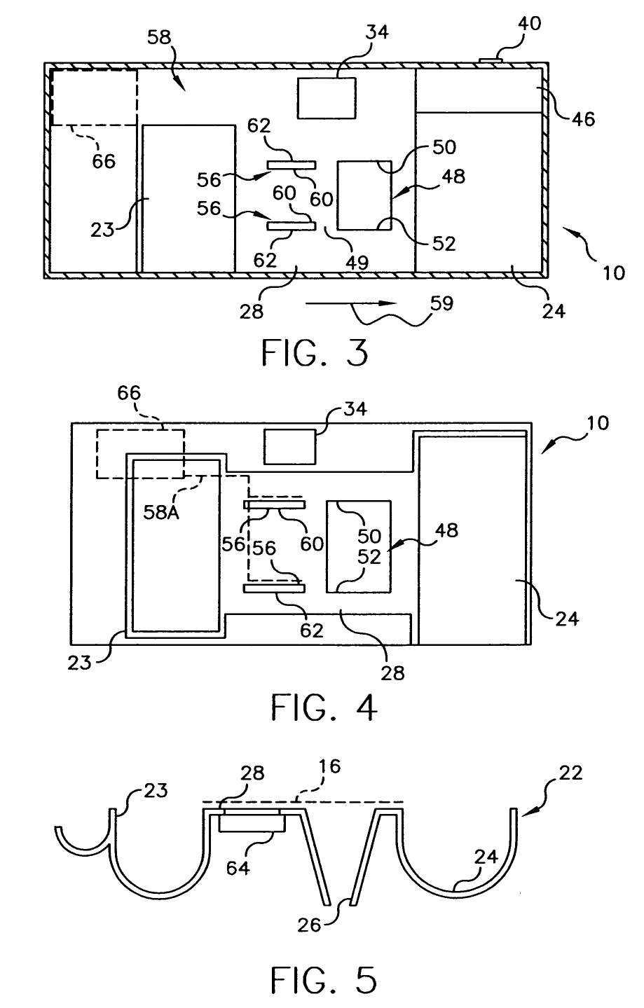

The filmstrip 16 is advanced through the film support 28 sequentially, for each image capture. In the one-time-use camera 10 shown, the filmstrip 16 is prewound out of the film canister 29 into the film roll during camera assembly. The operating mechanism 36 includes a shutter 35, a shutter release 40, and a film metering mechanism (indicated by box 46 in FIG. 3).

The filmstrip 16 is advanced and the shutter 35 is charged by the film metering mechanism 46. The shutter release 40 is tripped by the user to release the shutter 35 for image exposure. A currently preferred embodiment of the camera uses the metering mechanism disclosed in U.S. Pat. No. 5,541,690, to Petruchik, which is hereby incorporated herein by reference. This mechanism has an impact shutter operated by a high-energy lever that is charged as film is metered by a film metering feature during rotation of a thumbwheel to advance the filmstrip. The length of filmstrip advanced alternates between the length of a half-frame and the length of a half-frame plus an interspace. As a result, a sequence of captured images is in the form of half-frame pairs, each having two contiguous half-frame images, separated by interspaces.

The film support 28 has a rectangular exposure opening 48 and a pair of demarcation openings 56. The film support 28 has an opaque interspace mask 49 located between the exposure opening 48 and the demarcation openings 56.

A single demarcation opening 56 can be used, but a pair of demarcation openings 56 are preferred to provide redundancy to reduce the chance of scanner error. For convenience, the following discussion is limited to an embodiment having a pair of demarcation openings. Like considerations apply to an embodiment having a single demarcation opening.

The baffle 26, which is disposed between the taking lens 32 and the film support 28, directs the light image along a light cone 54 from the taking lens 32 to the film support 28. The light image is propagated through the exposure opening 48 to the filmstrip 16 exposing the image frame 42. The filmstrip 16 is pressed closely against the film support 28 by the back cover 20 or another feature of the camera body 12.

Light is propagated through the demarcation openings 56 concurrent with image capture. That light can be supplied by the light cone 54, but this is not preferred, since this light source is undependable to provide a full exposure. It is preferred that the light propagated through the demarcation openings 56 is supplied by a lamp 64 within the camera that is actuated for each image exposure. The lamp 64 can be mounted in or directly behind the demarcation openings 56, as shown in FIG. 5.

Alternatively, the body 12 can have an auxiliary light path 58 that extends between the demarcation openings 56 and lamp 64. The auxiliary light path 58 diverts light from the lamp 64 to the demarcation openings 56 and through the demarcation openings 56 to the filmstrip 16. The auxiliary light path 58 and the light cone propagated through the baffle 26 are fully isolated from each other. In a particular embodiment, shown in FIG. 2, the front cover 18 and main member 22 define the auxiliary light path 58 within the body 12, and the auxiliary light path 58 transmits light from a flash-tube-reflector assembly 66 (also referred to herein as a “head 66”) of the flash unit 33 to the demarcation openings 56. FIG. 4 illustrates another camera 10, in which the auxiliary light path 58 is a light pipe 58a (shown in FIG. 4 by dashed lines) that transmits light from the head 66 to the demarcation openings 56. Light can be propagated outward from the lightpipe 58a to the demarcation openings 56, by appropriately positioned scratches or other reflecting features.

The lamp 64 is actuable to direct a beam of illumination through the demarcation openings 56 to the film. The lamp 64 can be the flash unit 33 of the camera 10. In the camera 10 shown in FIG. 2, a gap 68 in the body 12, adjacent the head 66 of the flash unit 33, allows a portion of light emitted by the flash unit 33 to enter the auxiliary light path 58 and be diverted to the demarcation openings 56. The lamp 64 can also be separate from the flash unit 33. A convenient separate lamp is a light emitting diode or small tungsten lamp.

It is highly preferred that the lamp 64 is illuminated for each capture event. It is preferred that a uniform exposure be provided through the demarcation openings 56 for each capture event. Circuits that fire a flash unit at every exposure are very well known to those of skill in the art. Such circuits can also be readily modified to light a light emitting diode (LED) at the same time or instead of the flash unit. In a simple case, the LED or other lamp 64 can be provided as part of the flash unit 33 of the camera 10 and the flash unit 33 and lamp 64 are fired with every exposure. A lamp that is independent of the flash unit can also be operated by synch contacts (not shown) like those used for flash units. Such synch contacts are well known to those of skill in the art. Lighting duration can be the same for each exposure and, if necessary, can be determined by a timer circuit or can be provided as a clock function of a camera microprocessor or other computing device of a camera control system (not shown).

The film support 28 has a pair of longitudinally extending edges 50,52 that define the lateral boundaries, i.e., the top and bottom, of the exposure opening 48. The demarcation openings 56 extend longitudinally and are each aligned with a respective edge 50 or 52 of the film support. The demarcation openings 56 are spaced from the exposure opening 48 by the interspace mask 49. The demarcation openings 56 are elongate and equal in length to the longitudinal dimension of the exposure opening.

The demarcation openings 56 each have a pair of opposed inner and outer long edges 60,62. The demarcation openings 56 are laterally aligned with respective lateral edges 50,52 of the exposure opening 48. The demarcation openings 56 can be located such that either the outer long edges 62 are located in alignment with respective lateral edges 50,52 or inner long edges 60 are located in alignment with respective lateral edges 50,52 or outer long edges 62 are located laterally outboard of respective lateral edges 50,52 and inner long edges 60 are located laterally inboard of respective lateral edges 50,52. Resulting demarcation bars 70 exposed on the film 16 fully overlap an adjoining captured image 71 or are contiguous without overlap or partially overlap. In any case, the demarcation bars 70 and images 71 are all located inboard of film perforations 72, within the portion of the filmstrip 16 reserved for image capture. The demarcation bars 70 can extend farther outward in a lateral direction, but such extension is surplusage and is not preferred.

The width of the demarcation openings 56 can vary, but narrow demarcation openings 56 are preferred, in that increased width of the demarcation openings 56 reduces the area of film available for image capture. Excessively large demarcation openings also increase the risk of image degradation due to light scattering. It is therefore preferable that the demarcation openings 56 have a width in a direction perpendicular to the direction of film transport between 0.5 mm and 1.0 mm. The direction of film transport is indicated by arrow 59, in FIG. 3.

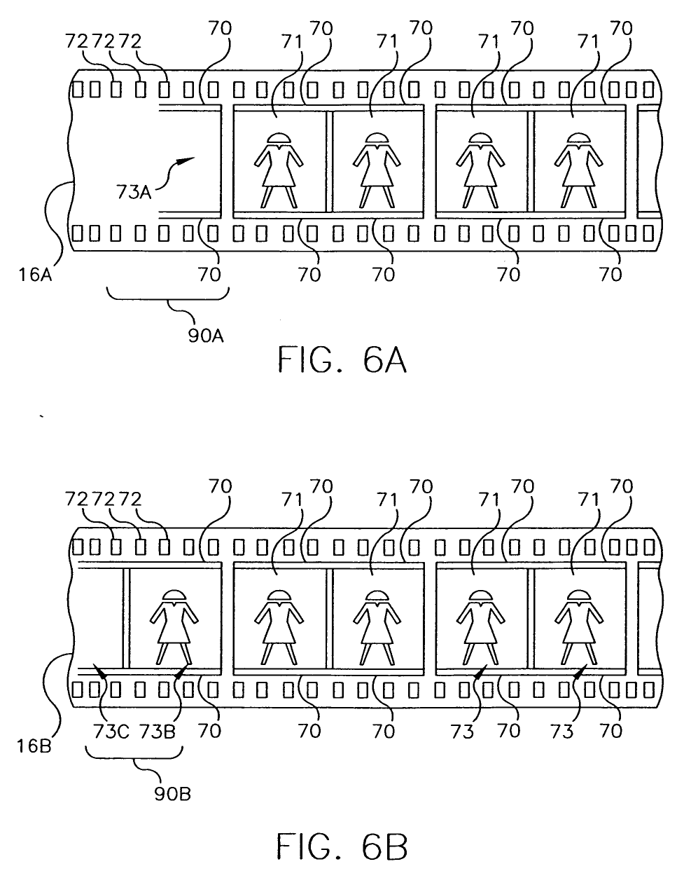

In use, the film support 28 supports a segment of film that includes two half-frames 73. One of the half-frames 73 is in position for picture taking. The other half-frame 73 is in position for marking. When an image 71 is captured on a half-frame 73 of film 16, a pair of demarcation bars 56 on the next half-frame 73 are exposed concurrently. (The captured image and exposed demarcation bar are latent images corresponding, in a particular embodiment, to the difference between FIGS. 6A and 6B.) The demarcation openings 56 and the intensity of the light provided for exposure of demarcation bars 70 are such that, after development of the film 16, the exposed elongated demarcation bars 70 have a uniform high density value.

The demarcation openings 56 are through-slots or, alternatively, the demarcation openings 56 are made of a material that is sufficiently transparent or translucent that light passes through without excessive absorption. The amount of absorption is excessive, if the demarcation bar 70 can no longer be distinguished by the film notch scanner.

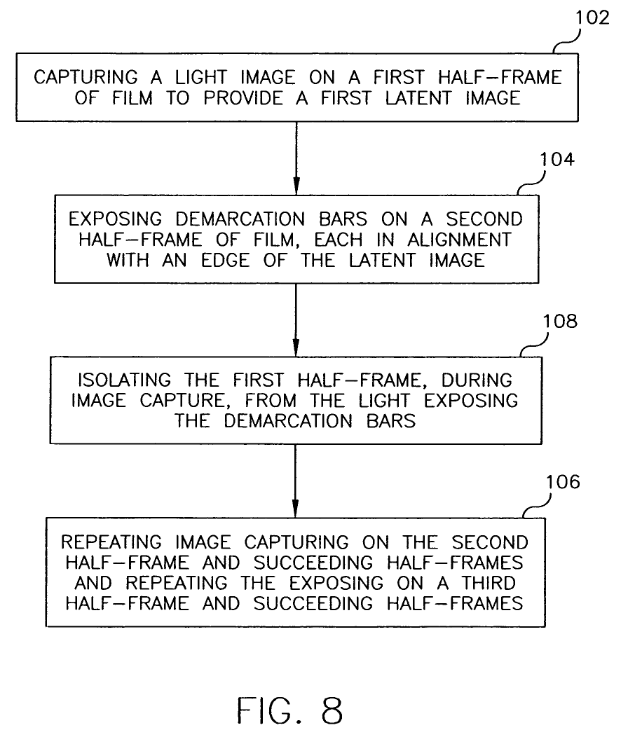

Referring to an embodiment shown in FIG. 8, in the method half-frames of photographic film are optically delimited in the camera. A photographer actuates the shutter 35 and a light image is captured (102) on a first half-frame of photographic film to provide a first latent image. Concurrently, the flash unit or other lamp of the camera is fired. Some of the emitted light is diverted along the auxiliary light path 58 and through the exposure demarcation openings 56, which exposes (104) demarcation bars on a second half-frame of the film. The procedure continues (106) for succeeding half-frames. The photographer captures a second latent image that overlaps or is contiguous with the demarcation bars earlier captured. When the second image is captured, a pair of demarcation bars are exposed on a third half-frame of film. This is repeated for succeeding half-frames. When images are captured, respective half-frames are isolated (108) from the light used to concurrently expose demarcation bars 70.

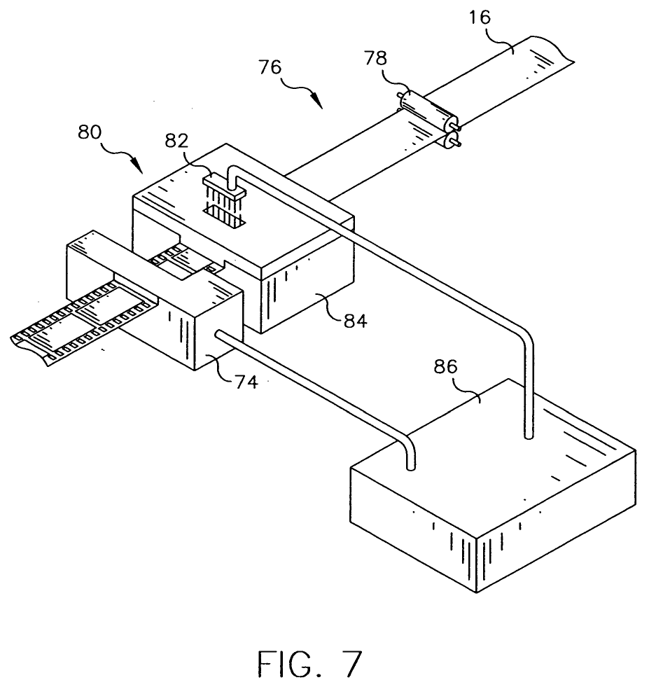

FIG. 7 schematically depicts an embodiment of the film notch scanner 76 that makes prints or other final images from archival images recorded in successive pairs of half-frames of the filmstrip 16. Use of the film notch scanner 76 is preceded by development of filmstrip, using a chemical processor (not shown) to develop the film and make the latent images visible. A motorized film drive 78 advances the filmstrip 16 from a film supply reel (not shown), through a scanning unit 80 and notching unit 74 and onto a film take-up reel (not shown). Filmstrips 16 from many film units can be spliced together into a continuous web on the film supply reel.

The scanning unit 80 has an illuminator 82 that directs light through a full frame length segment of the filmstrip to a scanner head 84. The scanner head 84 has an image sensor such as a charge-coupled device (CCD). The resultant analog electronic image provided by the image sensor is converted into digital form and amplified as necessary by an analog to digital (“A/D”) converter (not shown) and sent to a control unit 86. The control unit 86 is a programmable computer or the like, which controls the operation of a notching unit.

FIGS. 6A-6B illustrate a pair of developed filmstrips 16a, 16b produced by a camera like that disclosed in U.S. Pat. No. 5,541,690, to Petruchik. When these filmstrips 16a, 16b are input into the film notch scanner 76 of FIG. 6, the following occurs. Referring to FIG. 6A, in one of the filmstrips 16a, the last half-frame pair 90a has no images, but one of the half-frames 73a of the pair has demarcation bars 70. The final half-frame pair 90a will not be notched for printing, because it does not show exposure over the normal full image space in a lateral direction.

Referring to FIG. 6B, on another exposed filmstrip 16b, the last half-frame pair 90b has an image in one half-frame 73b, but not the other half-frame 73c. Demarcation bars 70 are present in both members 73b,73c of the half-frame pair 90b. The last half-frame pair 90b meets the requirement of exposure over the normal full frame image space in a lateral direction. The demarcation bars 70, in combination with the image 71 in the first half-frame 73b provide exposure content over the full length of the full frame. The film notch scanner recognizes the last half-frame pair 90b and notches the filmstrip for printing the last half-frame pair 90b.

After notching, the filmstrip can be printed using optical printing as discussed in U.S. Pat. No. 5,541,690 or can be printed using digital photofinishing equipment. In the latter case, the images are rescanned at higher resolution, digitally processed and send to an output device, such as a printer. The control unit of the film notch scanner can be a dedicated device or part of the digital photofinishing equipment. In the latter case, the central processing unit can be part of a control system sometimes referred to as an image data manager (IDM). The computer system or IDM includes memory and can include a display and user controls allowing for supervision and intervention by an operator. The photofinishing unit can be like that disclosed in U.S. Pat. No. 5,767,945 issued Jun. 16, 1998.

With the half-frame pairs of FIGS. 6A-6B, the digital photofinishing equipment digitally separates each of half-frame images to provide two separate images. Areas of overlap are cropped out. The images can be enlarged by 133 percent to provide standard size images at a standard aspect ratio. The resulting images are otherwise digitally processed and printed in the same manner as full frame images.

The invention has been described in detail with particular reference to certain preferred embodiments thereof, but it will be understood that variations and modifications can be effected within the spirit and scope of the invention.

1. A camera assembly for use with photographic film comprising:
a taking lens;
a baffle aligned with said taking lens;
a film metering mechanism actuable to transport said photographic film, in a longitudinal direction past said baffle;
a film support aligned with said baffle, said film support defining a pair of film stations separated by a light-blocking interspace mask, said first film station having an exposure opening and a pair of lateral edges adjoining said exposure opening, said second film station having a light-blocking image mask and an elongate demarcation opening adjoining said image mask in a second direction perpendicular to said direction of film transport, said exposure opening and said demarcation opening being equal in length in said direction of film transport, said demarcation opening being aligned with one of said lateral edges.

2. The camera assembly of claim 1 wherein said second film station has a second elongate demarcation opening adjoining said image mask in said second direction perpendicular to said direction of film transport, said exposure opening and said demarcation openings being equal in length in said direction of film transport, said demarcation openings each being aligned with a respective one of said lateral edges.

3. The method of claim 1 wherein said demarcation bar is aligned with a respective edge of said latent image.

4. The camera assembly of claim 1 wherein said demarcation window is spaced apart from said lateral edges in said longitudinal direction.

5. The camera assembly of claim 1 wherein said baffle is isolated from said demarcation opening.

6. The camera assembly of claim 5 further comprising a lamp actuable to direct a beam of illumination through said demarcation opening.

7. The camera assembly of claim 6 wherein said lamp is a flash unit.

8. The camera assembly of claim 1 wherein said film support is a part of a one-piece main member, which also includes a pair of opposed film chambers disposed on opposite sides of said film support.

9. The camera assembly of claim 1 wherein said exposure opening and said demarcation opening are both one-half frame long.

10. A camera assembly for use with photographic film comprising:
a taking lens;
a baffle aligned with said taking lens;
a film metering mechanism actuable to transport said photographic film, in a longitudinal direction past said baffle;
a film support aligned with said baffle, said film support defining a pair of film stations separated by a light-blocking interspace mask, said first film station having a half-frame long exposure opening and a pair of lateral edges adjoining said exposure opening, said second film station having a light-blocking image mask and a pair of half-frame long demarcation openings adjoining said image mask in said second direction perpendicular to said direction of film transport, said exposure opening and said demarcation openings being equal in length in said direction of film transport, said demarcation openings each being aligned with a respective one of said lateral edges.

11. The camera assembly of claim 10 further comprising a lamp actuable to direct a beam of illumination through said demarcation opening.

12. The camera assembly of claim 11 wherein said lamp is a flash unit.

13. A half-frame delimiting photography method for use with a camera and photographic film, said method comprising the steps of:
capturing a light image on a first half-frame of the film to provide a latent image; and
during said capturing, exposing a demarcation bar on a second half-frame of said film, said half-frames adjoining in a longitudinal direction, said latent image and said demarcation bar being equal in length in said longitudinal direction.

14. The method of claim 13 further comprising, following said exposing, capturing a second light image on said second half-frame of said film to provide a second latent image adjoining said demarcation bar.

15. The method of claim 14 wherein said demarcation bar is aligned with an edge of said latent image.

16. The method of claim 13 further comprising repeating said capturing on said second half-frame and succeeding half-frames of said film and repeating said exposing on a third half-frame and succeeding half-frames of said film.

17. The method of claim 13 further comprising isolating said first half-frame from said exposing during said capturing of said latent image.

18. The method of claim 13 wherein said exposing further comprises firing a lamp of the camera and directing light emitted by the lamp to said second half-frame to expose said demarcation bar.

19. The method of claim 13 wherein said exposing is further characterized as exposing a pair of demarcation bars on said second half-frame of said film, said latent image and said demarcation bars being equal in length in said longitudinal direction.

20. The method of claim 19 wherein each of said demarcation bars is aligned with a respective edge of said latent image.
